(19) United States
(12) Patent Application Publication
(10) Pub. No.: US 2025/0217073 A1
(43) Pub. Date: Jul. 3, 2025

(54) STORAGE SYSTEM

(71) Applicant: Hitachi Vantara, Ltd., Yokohama-shi (JP)

(72) Inventors: Shugo OGAWA, Tokyo (JP); Nobuhiro YOKOI, Tokyo (JP); Tomohiro YOSHIHARA, Tokyo (JP); Takayuki FUKATANI, Tokyo (JP)

(21) Appl. No.: 18/882,368

(22) Filed: Sep. 11, 2024

(30) Foreign Application Priority Data
Dec. 28, 2023 (JP) 2023-222256

(51) Int. Cl. G06F 3/06

(52) U.S. Cl. CPC G06F 3/0656; G06F 3/0604; G06F 3/0631; G06F 3/067

(57) ABSTRACT

A storage system includes a controller and a network interface device connected to the controller. The network interface device receives an access request from a host, converts the access request into an access request interpretable by the controller, and issues the access request to the controller. In processing in response to a data writing request from the host, the network interface transmits a message for an instruction to start transmission of writing target data to the host, and then allocates a buffer that temporarily stores writing target data, stores the writing target data received from the host in the buffer, and transfers the writing target data stored in the buffer to the controller.

### CLAIM OF PRIORITY

The present application claims priority from Japanese patent application JP 2023-222256 filed on Dec. 28, 2023, the content of which is hereby incorporated by reference into this application.

### BACKGROUND OF THE INVENTION

### 1. Field of the Invention

The present invention relates to a storage system.

### 2. Description of the Related Art

With the development of computer systems, new protocols and functions have been used, and it is required to support storage systems that saves data. In addition, the recent storage systems are required to quickly support these new protocols and functions that appear one after another.

On the other hand, in a storage system that saves data, in order to achieve high reliability and availability, special hardware and software different from hardware and software for general computer systems may be used in preparation for various failures. In addition of protocols and functions in such a storage system, it is difficult to use software assuming a configuration of a general computer system, and development for a system having a special configuration is required, so that it is difficult to support the addition of protocols and functions quickly.

As a technique for solving these problems, US 2023/0328008 A discloses a storage system using a SmartNIC. The SmartNIC has system software and hardware such as a CPU and a memory capable of executing a program on a network card, and can add a user program for performing packet processing.

By adding a SmartNIC to the storage system, mounting software on the added SmartNIC, and sharing a part of processing performed by a controller of a storage, it is possible to support a new protocol or function without changing the configuration of the storage system, or hardware or software of the controller that performs control. In addition, if the known software created for a general computer system can be used on the SmartNIC, the time required for development can be further shortened to shorten a period for supporting the new protocol or function.

In a case where the SmartNIC is added to the storage system to share the processing of the controller, there is a problem that hardware performance is lower than that of a controller body. US 2023/0328008 A discloses a technique for preventing a buffer allocated in a memory on a SmartNIC from overflowing from a CPU cache to avoid an access to a low-speed memory for the purpose of increasing a speed of front-end processing in a storage using the SmartNIC.

### SUMMARY OF THE INVENTION

In a case where a SmartNIC that performs front-end processing of the storage system receives a Write request from a host, it is necessary to allocate a buffer for temporarily storing Write data on a memory of the SmartNIC. In a case where the allocated buffer is stored in the cache of the CPU mounted on the SmartNIC, data on the buffer is read and written without a low-speed memory access.

However, in a case where a large number of Write requests are continuously received from the host, it is not possible to store the buffer in the cache of the CPU on the SmartNIC, and an access to a low-speed memory occurs. As a result, there is a problem that transfer of Write data transmitted from the host to the storage controller is delayed, and Write performance is degraded. In many cases, the SmartNIC has lower hardware performance than the controller body, and the influence of Write performance degradation due to a cache miss of the CPU tends to be large.

When receiving a Write request from the host, the program of the front-end processing performed by the CPU mounted on the SmartNIC allocates a buffer on the memory of the SmartNIC in accordance with the size of Write target data. For example, software that performs the front-end processing of the storage can allocate a buffer after receiving a Write request from the host, and then instruct the host to transmit Write target data.

In this processing method, while data can be immediately stored in the allocated buffer when Write target data arrives from the host, the buffer is continuously allocated even while waiting until the Write target data arrives from the host. Therefore, the buffer capacity to be allocated increases in proportion to the number of Write requests to be processed at the same time.

As a result, when the total capacity of the buffer exceeds the capacity that can be stored in the cache of the CPU, an access to a low-speed memory occurs, leading to degradation of Write performance. In addition, as the network delay between the host and the SmartNIC increases, the time for waiting for data arrival from the host increases, so that more buffers are allocated at the same time, and thus Write performance is likely to degrade.

According to an aspect of the present invention, a storage system includes a controller, a network interface device connected to the controller. The network interface device receives an access request from a host. The network interface device converts the access request into an access request interpretable by the controller and issues the access request to the controller. In processing in response to a data writing request from the host, the network interface device transmits a message for an instructing to start transmission of writing target data to the host, and then allocates a buffer that temporarily stores the writing target data, stores the writing target data received from the host in the buffer, and transfers the writing target data stored in the buffer to the controller.

According to the aspect of the present invention, it is possible to improve write performance in a storage system.

Objects, configurations, and advantageous effects other than those described above will be clarified by the descriptions of the following embodiments.

### BRIEF DESCRIPTION OF THE DRAWINGS

FIG. 1 is a diagram illustrating a configuration example of a storage system in an embodiment;

FIG. 2 is a diagram illustrating a configuration example of a SmartNIC in the embodiment;

FIG. 3 is a diagram illustrating a configuration example of stored data in a memory of the SmartNIC in the embodiment;

FIG. 4 is a diagram illustrating a configuration example of a metadata area stored in the memory of the SmartNIC in the embodiment;

FIG. 5A is a flowchart illustrating a flow of processing in response to a Write request by the SmartNIC and a controller in the embodiment;

FIG. 5B is a flowchart illustrating the flow of the processing in response to the Write request by the SmartNIC and the controller in the embodiment;

FIG. 5C is a flowchart illustrating the flow of the processing in response to the Write request by the SmartNIC and the controller in the embodiment;

FIG. 6 is a diagram illustrating a period during which a buffer is allocated in the processing in response to the Write request by the SmartNIC and the controller in the embodiment;

FIG. 7 is a diagram illustrating a period during which a buffer is allocated in processing in response to a Write request by a SmartNIC and a controller in another embodiment; and

FIG. 8 is a diagram illustrating a period during which a buffer is allocated in processing in response to a Write request by a SmartNIC and a controller in the related art.

### DESCRIPTION OF THE PREFERRED EMBODIMENTS

In the following description, when there is a need for convenience, the description will be made by being divided into a plurality of sections or embodiments, but unless otherwise specified, the sections or embodiments are not unrelated to each other, and one is in a relationship with some or all modification examples, details, supplementary explanation, and the like of the other. In addition, in the following description, when referring to the number of elements or the like (including the number of pieces, a numerical value, an amount, a range, and the like), the number is not limited to a specific number unless otherwise specified or obviously limited to the specific number in principle, and the number may be greater than or equal to the specific number or may be less than or equal to the specific number.

In an embodiment of the present specification, writing performance from a host to a storage is improved in a storage system in which front-end processing in response to an access request from the host is performed by an interface device outside a controller such as a network card.

In an embodiment of the present specification, front-end processing of the storage system performed by the interface device instructs the host to start transmission of Write target data before allocating a buffer when a Write request is received from the host. As a result, by shortening a buffer allocating time for each Write request and reducing the total capacity of the buffer allocated at the same time, it is possible to suppress and prevent an increase in the cache miss of a processor in the interface device and improve Write performance. In an embodiment of the present specification, the buffer may be allocated when a response from the host to an instruction to start transmission of Write target data has been received. As a result, it is possible to more effectively improve the Write performance.

In an embodiment of the present specification, the buffer may be allocated when Write target data is arrived from the host to the interface device, and the received Write target data may be temporarily stored. By delaying a buffer allocating time until the arrival of the Write target data in front-end processing, it is possible to more effectively improve the Write performance.

In an embodiment of the present specification, a memory area to be used as the buffer to be allocated at the time of arrival of Write target data in the front-end processing that operates in the interface device may be prepared in advance such that the total capacity is within a cache capacity of the processor mounted on the interface device. By preparing the memory area for the buffer, it is possible to fix a range of the memory area of the buffer allocated during processing of a Write request and to suppress an occurrence of the cache miss of the processor.

Furthermore, in an embodiment of the present specification, in a case where the memory area is insufficient at the time of arrival of Write target data in the front-end processing that operates in the interface device, a reserve buffer area may be allocated and used. As a result, failure in allocating the buffer and an occurrence of timeout due to waiting for allocating the buffer are suppressed. Allocating of the reserve buffer area may be limited to only in a case where the memory area prepared for the buffer is insufficient. As a result, it is possible to reduce the frequency at which a memory area other than the memory area prepared in advance is used as the buffer, prevent an increase in the range of the memory area used as the buffer, and suppress the occurrence of the cache miss of the processor.

The above description can also be applied to the interface device having a programmable logic circuit configuration such as a field programmable gate array (FPGA) in addition to an interface device in which a function can be programmed by software executed by a processor. The FPGA may include a logic circuit that realizes each function implemented by a program and a cache memory used in arithmetic operation.

In the following description, an embodiment in which an access request from a host is processed in a storage system that performs front-end processing in response to an access request from the host in a SmartNIC will be described. A SmartNIC is a highly functional network card that can program (add) a function desired by a user by software or hardware, and is a front-end interface device. The SmartNIC may, for example, perform functions of an application layer above a transport layer. The present embodiment does not limit the claims of the present invention, and not all the elements described in the embodiment are necessary for solving the problems in the present invention.

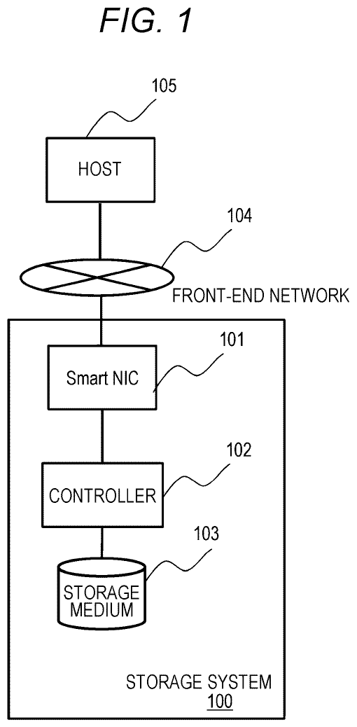

FIG. 1 is a diagram illustrating a configuration example of a storage system and a host that makes an access request to the storage system, according to an embodiment of the present specification. A storage system 100 includes a SmartNIC 101, a controller 102, and a storage medium 103. The storage system is connected to a front-end network 104 through the SmartNIC 101 to provide an access to an external host 105. The storage system 100 and the host 105 are connected via the front-end network 104, and the host 105 makes an access request to the storage system 100.

The SmartNIC 101 is a network interface for connecting the storage system 100 to the front-end network 104, and performs front-end processing of an access request from the host 105 to the storage system 100. When receiving an access request to the storage system 100 from the host 105 through the front-end network 104, the SmartNIC 101 interprets contents of the access request and converts the contents into a form interpretable by the controller 102. The SmartNIC 101 notifies the controller 102 of the converted access request, and transmits, as a response, a result of the access request to the host 105. The SmartNIC 101 performs data transfer for which a Read request or a Write request is requested from the host 105, to and from the controller 102.

The controller 102 receives an access request of the host 105 interpreted by the SmartNIC 101, and Reads or Writes a corresponding area of the storage medium 103 for data requested to be accessed. The storage medium 103 is connected to the controller 102 and provides a storage area of the storage system 100. The storage medium 103 may be mounted in a housing of the storage system 100 or may be connected to the controller 102 via an external network. The storage medium 103 may include, for example, one or more storage drives, and examples of the storage drives include hard disk drives, solid state drives, and the like.

The front-end network 104 connects the SmartNIC 101 and the host 105, and provides an access path from the host 105 to the storage system 100. The host 105 makes an access request to a storage area of the storage system 100 provided by the SmartNIC 101, the controller 102, and the storage medium 103.

The SmartNIC 101, the controller 102, and the storage medium 103, which are included in the storage system 100, and the host 105 that accesses the storage system 100 may be provided in plurals.

Furthermore, in the configuration of FIG. 1, the connection between the controller 102 and the SmartNIC 101 and the connection between the controller 102 and the storage medium 103 are not included in the front-end network 104, but one or both of the connections may be configured to be included in the front-end network 104.

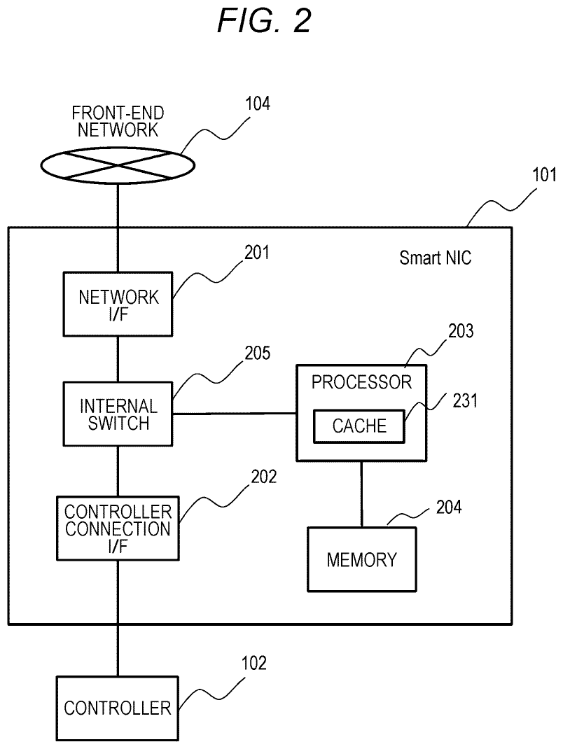

FIG. 2 is a diagram illustrating a configuration example of the SmartNIC 101 in the embodiment of the present specification. The SmartNIC 101 includes one or more network interfaces (I/Fs) 201, one or more controller connection I/Fs 202, one or more processors 203, one or more memories 204, and one or more internal switches 205.

The network I/F 201 is connected to the front-end network 104 and is used to transmit and receive data related to an access request from the host 105.

The controller connection I/F 202 connects the SmartNIC 101 and the controller 102, and is used for notification of an access request from the SmartNIC 101 to the controller 102, and transmission and reception of data for performing Read or Write.

The processor 203 can include one or more cores, and executes a program for performing front-end processing of an access request from the host 105 to the storage system and system software necessary for the execution.

The memory 204 stores system software including an operating system necessary for operating a program on the SmartNIC 101, a program operating on the processor 203, metadata used by the program, and data necessary to be temporarily saved. The data stored in the memory 204 is stored in a cache memory 231 of the processor 203. At the time of cache hit, the stored data can be referred to and updated without accessing the memory 204. The cache memory 231 is a memory that can be accessed from hardware that performs an arithmetic operation, here, the processor 203, at a higher speed than the memory 204 and the buffer area thereof. The cache memory 231 can be configured by one or more hierarchies.

The internal switch 205 connects the network I/F 201 and the controller connection I/F 202, and the processor 203.

Communication standards and protocols in the network I/F 201 and the controller connection I/F 202 are not particularly limited as long as the above operations can be performed. In addition, transmission and reception of data between the network I/F 201, the controller connection I/F 202, and the processor 203 is not limited to the configuration via the internal switch 205, and for example, the network I/F 201 and the controller connection I/F 202 may be connected to the processor 203.

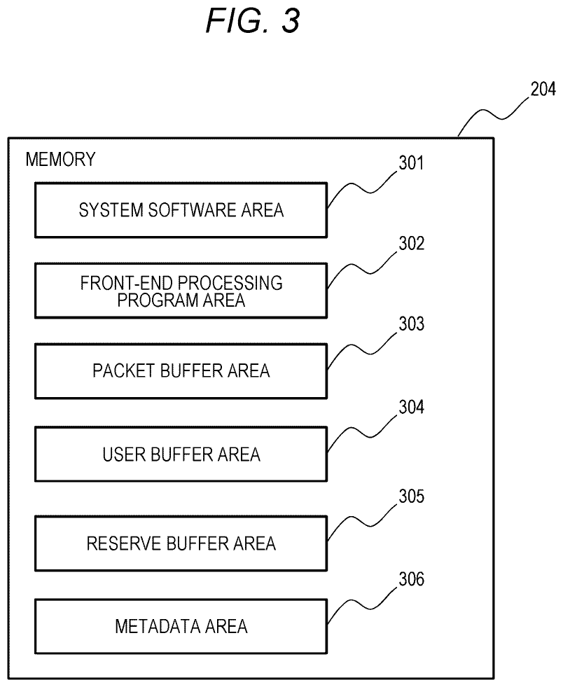

FIG. 3 is a diagram illustrating a configuration example of stored data in the memory 204 included in the SmartNIC 101 in the embodiment of the present specification. The memory 204 includes a system software area 301, a front-end processing program area 302, a packet buffer area 303, a user buffer area 304, a reserve buffer area 305, and a metadata area 306.

System software such as an operating system, a driver, and a library necessary for operating a user program such as front-end processing of the storage system in the processor 203 is stored in the system software area 301.

A front-end processing program that performs front-end processing executed on the processor 203 is stored in the front-end processing program area 302.

The packet buffer area 303 is an area managed by the OS, and data of a network packet received from the host 105 via the network I/F 201 is temporarily stored therein.

The user buffer area 304 is a memory area that is allocated and used by the front-end processing program, and data for which the host 105 has requested Write is temporarily stored therein. The user buffer area 304 allocated and used by the front-end processing program is limited by the maximum capacity determined in advance, in order to reduce an occurrence of an access to the memory 204 due to the cache miss. In an embodiment of the present specification, the total capacity of the user buffer area 304 is limited to be stored in the cache memory.

The reserve buffer area 305 is a memory area that is allocated and used by the front-end processing program, and is allocated as a buffer by the front-end processing program in a case where allocating of a buffer from the user buffer area 304 fails due to insufficient capacity. Differing from the user buffer area 304, the reserve buffer area 305 does not limit the allocated capacity of the buffer based on the cache capacity of the processor 203. The front-end processing program allocates, as the reserve buffer area 305, a capacity equal to or larger than the maximum capacity to be used in the processing of the access request from the host 105.

The metadata area 306 is a memory area used by the front-end processing program, and metadata necessary for the front-end processing is stored therein.

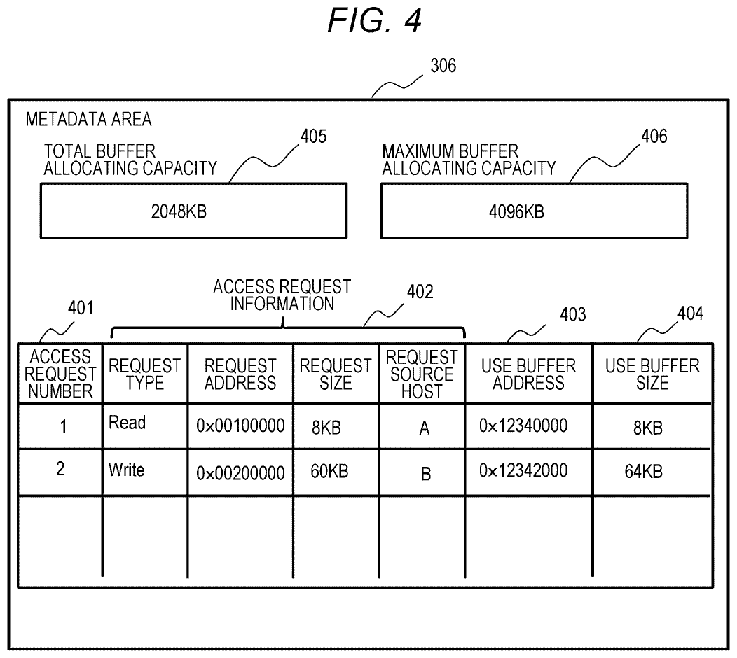

FIG. 4 is a diagram illustrating a configuration example of stored data included in the metadata area 306 of the memory 204 in the embodiment of the present specification. An access request number 401, access request information 402, a use buffer address 403, and a use buffer size 404 are stored for each access request in the metadata area 306. In addition, a total buffer allocating capacity 405 and a maximum buffer allocating capacity 406 are stored in the metadata area 306.

The access request number 401 is a unique number assigned to each access request in order to distinguish the access request received from the host 105.

The access request information 402 represents contents of the access request received from the host 105, and includes information such as an access type representing either Read or Write, an address and a size of access target data, and an address uniquely representing the host 105 as an access request source.

The use buffer address 403 represents the address of the user buffer area 304 or the reserve buffer area 305 allocated in the processing of each access request.

The use buffer size 404 represents the capacity of a buffer allocated from the user buffer area 304 or the reserve buffer area 305 in the processing of each access request.

The total buffer allocating capacity 405 represents the total capacity of the buffer included in the user buffer area 304 allocated by the front-end processing program in the processing of the access request.

The maximum buffer allocating capacity 406 represents the maximum capacity of the buffer allowed to be allocated from the user buffer area 304 by the front-end processing program. In order to prevent the cache miss in the processor 203 and writing of data overflowing from the cache, which cause an increase in access to the memory 204, the maximum buffer allocating capacity 406 is set in advance such that the capacity of the buffer allocated from the user buffer area 304 is within the cache capacity of the processor 203. In a configuration in which a plurality of processors are mounted, the cache capacity may be a total cache capacity of the processors.

The front-end processing program compares the total buffer allocating capacity 405 with the maximum buffer allocating capacity 406 at the time of allocating the buffer, and allocates a buffer having a capacity that does not exceed the maximum buffer allocating capacity 406 in the user buffer area 304 from the memory area. As a result, it is possible to suppress performance degradation due to overflow of data from the cache memory area while the memory area used as the buffer continues to remain in the cache memory area.

On the other hand, in a case where the total buffer allocating capacity 405 exceeds the maximum buffer allocating capacity 406 when the front-end processing program allocates the buffer, it is necessary to wait until the buffer allocated by the preceding Write request is released and the total buffer allocating capacity 405 after allocating the buffer does not exceed the maximum buffer allocating capacity 406.

At this time, in a case where it takes time to process the preceding Write request and the buffer is released late, the processing time of the Write request that waits for allocating the buffer increases to exceed the response time allowed by the host side, and a timeout occurs. The occurrence of the timeout may lead to an error or a failure in processing operated on the host side. Therefore, only in a case where the total buffer allocating capacity 405 exceeds the maximum buffer allocating capacity 406, the front-end processing program temporarily allocates the buffer from the reserve buffer area 305 to prevent the occurrence of waiting in the buffer allocating.

At this time, since the front-end processing program allocates the buffer not only from the user buffer area 304 but also from the reserve buffer area 305, the data of the buffer that is temporarily allocated overflows from the cache of the processor 203, which causes performance degradation. However, the buffer allocating from the reserve buffer area 305 is limited to a case where the total buffer allocating capacity 405 exceeds the maximum buffer allocating capacity 406, and when the buffer is released and the total buffer allocating capacity 405 is reduced, the front-end processing program allocates the buffer again only from the user buffer area 304. Thus, the frequency of the occurrence of the performance degradation is suppressed.

The data stored in the metadata area 306 is not limited to the configuration illustrated in FIG. 4. For example, the access request number 401 may be not a number but a character string or the like that can uniquely determine the access request. In a case where the buffer is allocated such that the size of the buffer allocated in the user buffer area 304 or the reserve buffer area 305 can be determined by the use buffer address 403 corresponding to each access request, the use buffer size 404 may be omitted. The maximum buffer allocating capacity 406 may be set such that, for example, a capacity obtained by adding a capacity of a program code and metadata having a high referring frequency in the front-end processing program, in addition to the capacity of the buffer allocated from the user buffer area 304, is within the cache capacity of the processor 203.

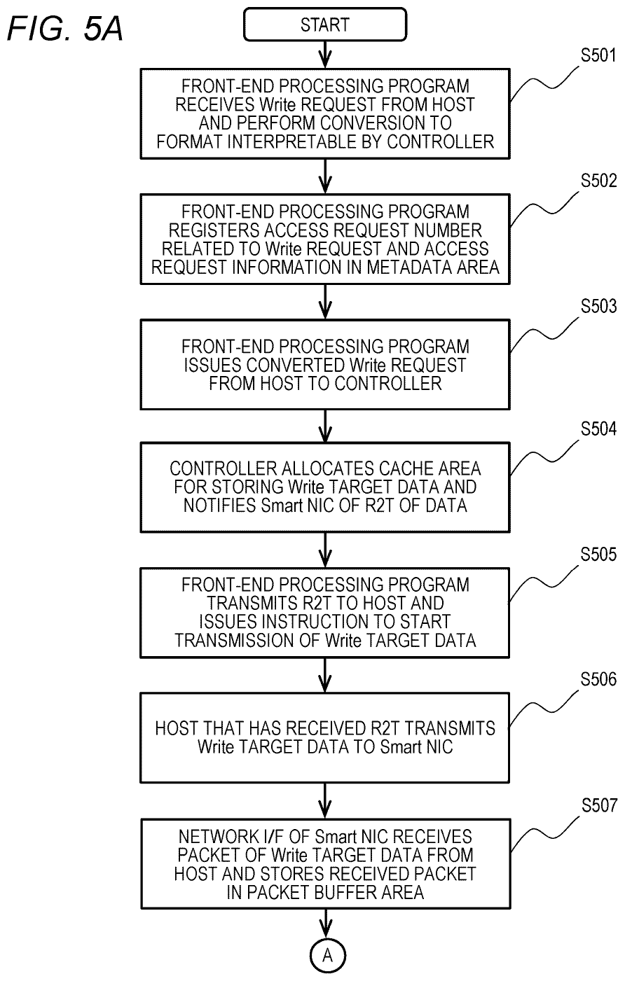

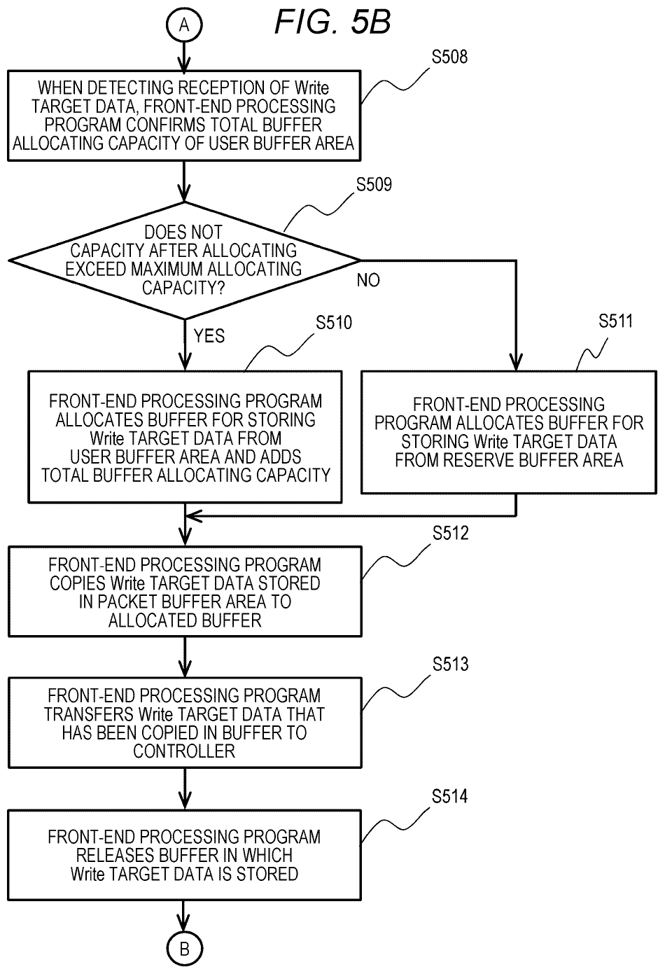

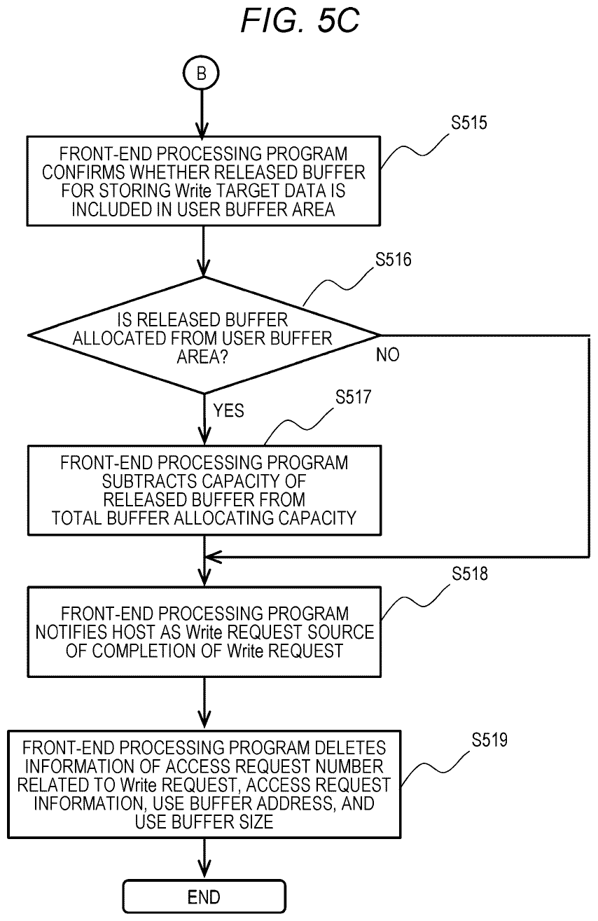

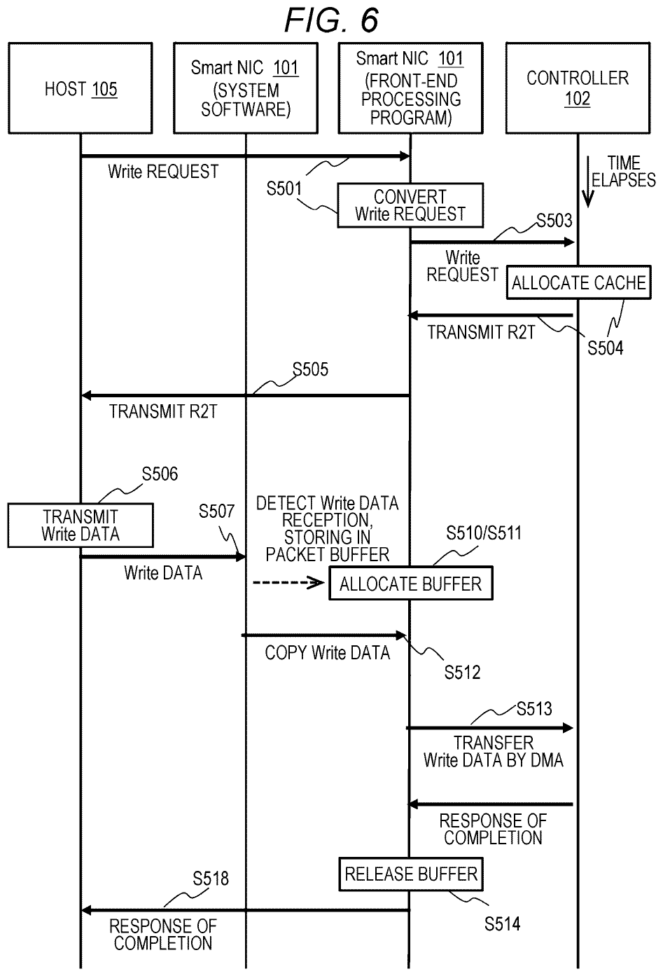

FIGS. 5A to 5C are flowcharts illustrating a flow of processing a Write request from the host 105 to the storage system by the SmartNIC 101 and the controller 102 in the embodiment of the present specification. FIG. 6 is a diagram illustrating a period during which a buffer is allocated in a case of processing a Write request from the host 105, in accordance with the flowcharts illustrated in FIGS. 5A to 5C. The operations based on the flowcharts in FIGS. 5A to 5C are as follows.

First, FIG. 5A is referred to.

Step 501: The front-end processing program that is being executed by the processor 203 of the SmartNIC 101 receives a Write request from the host 105 through the network I/F 201, converts the Write request into a format interpretable by the controller 102, and then executes Step 502.

Step 502: The front-end processing program that is being executed by the processor 203 of the SmartNIC 101 assigns the access request number 401 to the Write request received in Step 501 in the metadata area 306 of the memory 204, registers the Write request together with the access request information 402 related to the received Write request, and then executes Step 503.

Step 503: The front-end processing program that is being executed by the processor 203 of the SmartNIC 101 requests Write by notifying the controller 102 of the information converted in Step 501, and then executes Step 504.

Step 504: Upon receiving a Write request from the SmartNIC 101, the controller 102 allocates a cache area for storing data to be Written from the host 105 to the storage system on the controller 102. When the allocating of the cache area is completed, the controller 102 instructs the SmartNIC 101 to start transmission of Write target data by transmitting a message, and then executes Step 505. (In the present specification, a message for an instruction to start transmission Write target data is described below as R2T: Ready To Transfer.)

Step 505: Upon receiving R2T from the controller 102 through the controller connection I/F 202, the front-end processing program that is being executed by the processor 203 of the SmartNIC 101 instructs the host 105 to start transmission of Write target data by transmitting a message of R2T to the host 105 through the network I/F 201, and then executes Step 506.

Step 506: The front-end processing program that is being executed by the processor 203 of the SmartNIC 101 waits until the Write target data is received from the host 105. Upon receiving the message of R2T from the SmartNIC 101, the host 105 transmits the Write target data to the SmartNIC 101, and then executes Step 507.

Step 507: Upon receiving a packet including the Write target data from the host 105, the network I/F 201 of the SmartNIC 101 and the system software executed by the processor 203 store data included in the packet in the packet buffer area 303 of the memory 204, and then executes Step 508.

Next, FIG. 5B is referred to.

Step 508: When the front-end processing program that is being executed by the processor 203 of the SmartNIC 101 receives the packet including the Write target data from the host 105 in Step 507 and detects that the data is stored in the packet buffer area 303, the front-end processing program refers to the access request information 402, the total buffer allocating capacity 405, and the maximum buffer allocating capacity 406, which are included in the metadata area 306 of the memory 204, to confirm whether the total buffer allocating capacity 405 exceeds the maximum buffer allocating capacity 406 in a case where the buffer that stores the Write target data is allocated from the user buffer area 304, and then executes Step 509.

Step 509: As a result of confirmation in Step 508, the front-end processing program that is being executed by the processor 203 of the SmartNIC 101 executes Step 510 in a case where the total buffer allocating capacity 405 does not exceed the maximum buffer allocating capacity 406, and executes Step 511 in a case where the total buffer allocating capacity exceeds the maximum buffer allocating capacity.

Step 510: The front-end processing program that is being executed by the processor 203 of the SmartNIC 101 allocates a buffer that stores the Write target data from the user buffer area 304, and stores the use buffer address 403 corresponding to the currently-processed Write request and the address and capacity of the buffer allocated in the use buffer size 404, in the metadata area 306 of the memory 204. In addition, the front-end processing program adds and updates the capacity of the buffer having the allocated total buffer allocating capacity 405, and then executes Step 512.

Step 511: The front-end processing program that is being executed by the processor 203 of the SmartNIC 101 allocates the buffer that stores the Write target data from the reserve buffer area 305, stores the use buffer address 403 corresponding to the currently-processed Write request and the address and capacity of the buffer allocated in the use buffer size 404 in the metadata area 306 of the memory 204, and then executes Step 512.

Step 512: The front-end processing program that is being executed by the processor 203 of the SmartNIC 101 copies the Write target data stored in the packet buffer area 303 to the buffer allocated in Step 510 or Step 511, and then executes Step 513.

Step 513: The front-end processing program that is being executed by the processor 203 of the SmartNIC 101 transfers the Write target data copied in Step 512 to the controller 102 through the controller connection I/F 202, and then executes Step 514. For example, in a case where the SmartNIC 101 is connected to the controller 102 by PCI-Express (trademark), the data transfer in this step can be realized by using DMA transfer for the buffer allocated by the front-end processing program, but the means is not limited.

Step 514: When the transfer of the Write target data to the controller 102 is completed, the front-end processing program that is being executed by the processor 203 of the SmartNIC 101 releases the buffer allocated in Step 510 or Step 511, and then executes Step 515.

Next, FIG. 5C is referred to.

Step 515: The front-end processing program that is being executed by the processor 203 of the SmartNIC 101 confirms whether the buffer released in Step 514 is allocated from the user buffer area 304 or the reserve buffer area 305, and then executes Step 516. The confirmation of the area including the released buffer in this step can be realized, for example, by referring to the use buffer address 403 included in the metadata area 306, but the means is not limited.

Step 516: The front-end processing program that is being executed by the processor 203 of the SmartNIC 101 executes Step 517 if the buffer released in Step 514 is allocated from the user buffer area 304, and executes Step 518 if the buffer is allocated from the reserve buffer area 305.

Step 517: The front-end processing program that is being executed by the processor 203 of the SmartNIC 101 is updated by subtracting the capacity of the released buffer from the total buffer allocating capacity 405 included in the metadata area 306, and then, executes Step 518.

Step 518: The front-end processing program that is being executed by the processor 203 of the SmartNIC 101 refers to the access request information 402 included in the metadata area 306 to specify the host that has made the currently-processed Write request, performs notification of completion of the Write request through the network I/F 201, and then executes Step 519.

Step 519: The front-end processing program that is being executed by the processor 203 of the SmartNIC 101 deletes the information of the access request number 401, the access request information 402, the use buffer address 403, and the use buffer size 404 corresponding to the Write request as a processing target from the metadata area 306, and ends a series of operations.

The completion of the notification of the Write request to the host 105 in Step 518 of the flowchart of FIG. 5C may be performed at any time after completion of the transfer of the Write target data to the controller 102 in Step 513 and before execution of Step 519. The time at which the controller 102 stores the Write target data transferred from the SmartNIC 101 in Step 513 in the storage medium 103 is not limited, and may be at any time.

In addition, in Step 506 of the flowchart of FIG. 5A, in a case where the host 105 receives the message of R2T from the SmartNIC 101 and then transmits a response (R2T ACK) to R2T before transmitting the Write target data to the SmartNIC 101, the front-end processing program that is being executed by the processor 203 of the SmartNIC 101 may execute the processes of Steps 508 and 509 when the message of R2T ACK has been received from the host 105.

At this time, the network I/F 201 executes the process of Step 507 before Step 512 when the Write target data has been received from the host 105. The front-end program executes the process of Step 512 and the subsequent steps when the Write target data has been stored in the packet buffer area 303 in Step 507.

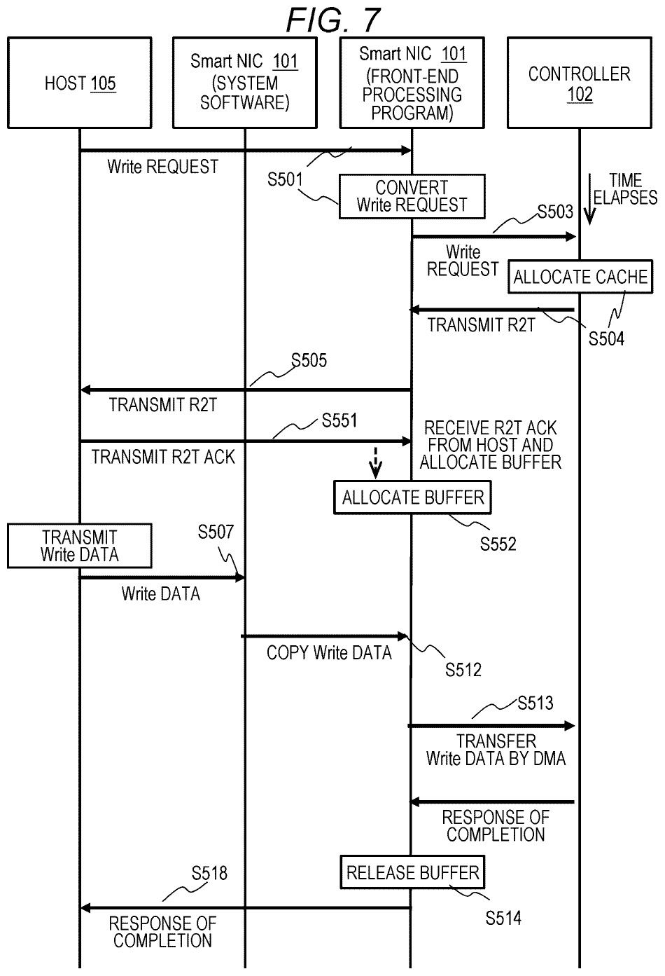

As described above, FIG. 6 illustrates the embodiment of the present specification, and is a diagram illustrating the period during which the buffer is allocated in a case of processing a Write request from the host 105 in accordance with the flowcharts illustrated in FIGS. 5A to 5C. In addition, FIG. 7 illustrates the embodiment of the present specification, and is a diagram illustrating the period during which the buffer is allocated in a case where the buffer is allocated in Step 552 when an R2T ACK message transmitted from the host 105 before the Write target data in Step 551 has been received, in the flowcharts illustrated in FIGS. 5A to 5C.

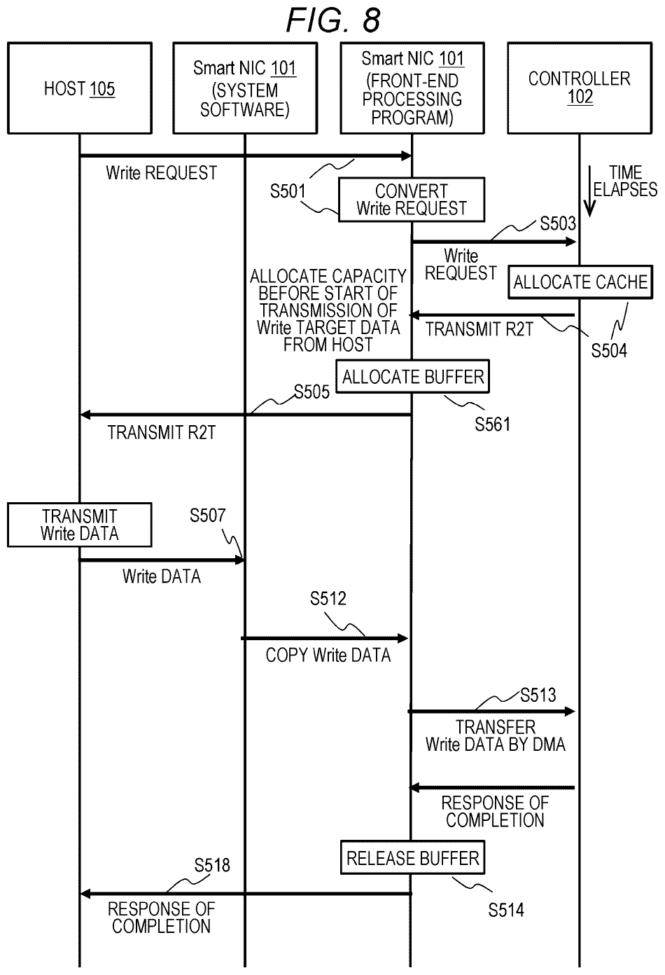

FIG. 8 illustrates the related art, and is a diagram illustrating the period during which the buffer is allocated in a case where the buffer that stores Write target data is allocated in Step 561 before the message of R2T is transmitted to the host 105 in Step 505, differing from the flowcharts illustrated in FIGS. 5A to 5C.

First, comparing FIG. 6 with FIG. 8, in a case where the Write request is processed in accordance with the flowcharts illustrated in FIGS. 5A to 5C, the buffer is allocated after the Write target data is received from the host 105, so that the time from the allocating of the buffer to the release is shortened.

In addition, comparing FIG. 7 with FIG. 8, even in a case where the buffer is allocated when the message of R2T ACK has been received, the buffer allocating time corresponding to the time when the message of R2T ACK is transmitted from the SmartNIC 101 to the host 105 and then the message of R2T ACK is received from the host 105 is shortened. Therefore, in a case where Write is continuously requested from the host 105, it is possible to reduce the total capacity of the buffer allocated at the same time, to reduce the frequency at which the data of the buffer overflows from the cache of the processor 203, and to improve the throughput of Write with respect to the storage system.

According to the embodiment of the present specification, in the storage system in which front-end processing in response to an access request from the host is performed by the SmartNIC, it is possible to prevent data of the buffer allocated in response to a Write request from the host from overflowing from the cache of the processor on the SmartNIC, and to improve the throughput of Write with respect to the storage system.

The present invention is not limited to the above embodiments, and various modification examples may be provided. For example, the above embodiments are described in detail in order to explain the present invention in an easy-to-understand manner, and the above embodiments are not necessarily limited to a case including all the described configurations. Further, some components in one embodiment can be replaced with the components in another embodiment, and the configuration of another embodiment can be added to the configuration of one embodiment. Regarding some components in the embodiments, other components can be added, deleted, and replaced.

Some or all of the configurations, the functions, the processing units, and the like described above may be realized in hardware by being designed with an integrated circuit, for example. Further, the above-described respective components, functions, and the like may be realized by software by the processor interpreting and executing a program for realizing the respective functions. Information such as a program, a table, and a file, that realizes each function can be stored in a memory, a recording device such as a hard disk and a solid state drive (SSD), or a recording medium such as an IC card, and an SD card.

Control lines and information lines considered necessary for the descriptions are illustrated, and not all the control lines and the information lines in the product are necessarily shown. In practice, it may be considered that almost all components are connected to each other.

What is claimed is:

1. A storage system comprising:
a controller;
a network interface device connected to the controller, wherein
the network interface device receives an access request from a host,
the network interface device converts the access request into an access request interpretable by the controller and issues the access request to the controller,
in processing in response to a data writing request from the host, the network interface device
transmits a message for an instructing to start transmission of writing target data to the host, and then allocates a buffer that temporarily stores the writing target data,
stores the writing target data received from the host in the buffer, and
transfers the writing target data stored in the buffer to the controller.

2. The storage system according to claim 1, wherein
the network interface device allocates the buffer that temporarily stores the writing target data, when the writing target data has been received from the host.

3. The storage system according to claim 1, wherein
the network interface device allocates the buffer that temporarily stores the writing target data, when a response to the message has been received from the host.

4. The storage system according to claim 1, wherein
the network interface device includes
a processor that converts the access request into the access request interpretable by the controller and issues the access request to the controller, and
a cache of the processor, and
a total buffer capacity allocated for temporarily storing writing target data from the host is limited to be stored in the cache.

5. The storage system according to claim 1, wherein
the network interface device allocates a reserve memory area allocated in advance in a case where a total buffer capacity allocated for temporarily storing writing target data from the host exceeds a maximum capacity set in advance.

6. The storage system according to claim 1, wherein
the network interface device is able to make an implementation function programmed.

7. A method performed in a storage system including a network interface device connected to a controller, the method comprising:
by the network interface device,
receiving an access request from a host;
converting the access request into an access request interpretable by the controller and issuing the access request to the controller;
in processing in response to a data writing request from the host,
transmitting a message for an instructing to start transmission of writing target data to the host, and then allocating a buffer that temporarily stores the writing target data;
storing the writing target data received from the host in the buffer; and
transferring the writing target data stored in the buffer to the controller.

8. The method according to claim 7, further comprising:
by the network interface device,
allocating the buffer that temporarily stores the writing target data, when the writing target data has been received from the host.

9. The method according to claim 7, wherein
the total buffer capacity allocated for temporarily storing writing target data from the host is limited to be stored in a cache of a processor in the network interface device.

10. The method according to claim 7, further comprising:
by the network interface device,
allocating a reserve memory area allocated in advance in a case where a total buffer capacity allocated for temporarily storing writing target data from the host exceeds a maximum capacity set in advance.
